(19) United States
(12) Patent Application Publication
(10) Pub. No.: US 2012/0166996 A1
(43) Pub. Date: Jun. 28, 2012

(54) ANESTHESIA RECORDATION DEVICE

(75) Inventors: Courtney L. Leddell, Bloomington, IL (US); Bryan C. Griffin, Bellevue, WA (US)

(73) Assignee: GLOCKNER GROUP LLC, Bellevue, WA (US)

(21) Appl. No.: 12/978,285

(22) Filed: Dec. 23, 2010

(51) Int. Cl. G06F 3/048

(52) U.S. Cl. 715/777; 715/833

(57) ABSTRACT

A system, method and graphical user interface that allows for the intuitive and automatic collection of data using a portable computing device in an operating theater. Such a system may be used in a wide variety of applications in which a large range of data is periodically collected from multiple subjects. The invention may be especially useful in the medical arts—such as anesthesiology.

### BACKGROUND OF THE INVENTION

In many diverse environments, a large amount of data must be gathered and recorded for future use by one or more personnel related to the information thus gathered. Often times, data is gathered on multiple subjects at various recurring times in order to track changes that occur and determine whether to change the management of each particular subject. Management of these vast amounts of data, especially where the data for each subject must be kept isolated from other data, can be an onerous project. Historically, these data management systems constituted voluminous paper records and a complex web of sub-systems allowing for various subsequent tasks and records to be produced.

The medical field has countless examples of procedures in which data for many different patients must be collected over an extended period of time. For example, common today is the practice of making handwritten anesthesia records, handwritten pharmacy drug charge forms, handwritten quality assurance forms, handwritten supply charges (e.g., masks, tubing, syringes and other general hospital supplies), and handwritten anesthesia billing forms.

Such a practice is susceptible to mistakes particularly by not documenting appropriate information in view of a busy operating/procedure room environment. By not documenting appropriate information, insufficient information is recorded on the anesthesia record. If thereafter called upon by a medical or legal representative to review what occurred with a particular patient, there may be nothing recorded to verify care given. Further, because the operating/procedure room environment is extremely busy, anesthesia providers may miss documenting some details that lead to lost revenue and incomplete documentation of anesthestic provisions. There is a lack of uniformity among providers with regard to written records. Thus, there are no rules on where to place many items. For example, if one was reviewing a large number of records from a particular facility that utilized paper records, one could be presented with quite the challenge of trying to identify many details that may be sought after, not to mention recognizing handwritten characters.

By having to rely on handwritten documentation, time is wasted that could otherwise be used to direct and provide needed care to the patient. Further, there are triplicate copies of the multiple different forms created, losing just one particular form would have a significant negative impact on documentation, billing, drug charges, supply charges, or altering the results of quality assurance. By losing the anesthesia record, there is no documentation of what happened and what kind of care was provided. By losing the billing form, supply charges form, or pharmacy drug charge form, there is lost revenue, and by losing the quality assurance form, accurate results of the evaluation of care provided are not attainable.

Computer applications have been written to solve the issue of handwritten records. There use has increased significantly since the early 2000's. Yet they have been expensive, stationary, require large amount of support and service. Also, historically, they have been fixed in place and cannot be used for anything else.

Some prior art anesthesia applications are complicated and not straightforward to use, often requiring extensive training in order to use the application. This may create additional problems when new or temporary anesthesia providers, who are usually not given any orientation, is providing care. Also, because the application is typically set up such that data is automatically pulled from the patient monitors, errors can result on the anesthesia record due to a variety of circumstances. For example, this may occur when the surgeon is using an electrical cauterizing device, which interferes with the PC system, which in turn causes the PC to document spurious or incorrect data. Also, these applications gather data automatically only. Thus, there is usually no way to enter data manually. Therefore there is no way to correct incorrectly entered data.

These prior art systems are also limited because the data cannot be edited. If a problem occurs and the data needs to be examined, the anesthesia professional is therefore in the awkward position of defending a document that was intended to defend the user and to be used as a true representation of the patients vitals and such during anesthetic delivery. Available software packages make lives easier for anesthesia providers as they collect information and plot it automatically, but machines are subject to mistakes. It is ultimately up to the anesthesia providers to make sure that the documentation is correct.

### SUMMARY OF THE INVENTION

The present invention provides an integrated system that allows for the intuitive and automatic collection of data that also allows for automatic quality assurance processing and printing of reports, supply charges, and bills as desired. Such a system may be used in a wide variety of applications in which a large range of data is periodically collected from multiple subjects. The invention may be especially useful in the medical arts—such as anesthesiology. The present invention, in at least one preferred embodiment, addresses one or more of the above-described and other limitations to prior art systems.

### BRIEF DESCRIPTION OF THE DRAWINGS

Preferred and alternative examples of the present invention are described in detail below with reference to the following drawings:

FIG. 1 illustrates a block diagram of an exemplary system formed in accordance with an embodiment of the present invention; and

FIGS. 2-13 illustrate screen shots of exemplary user interfaces operable on a component of the system shown in FIG. 1 and formed in accordance with an embodiment of the present invention.

### DETAILED DESCRIPTION OF THE DRAWINGS

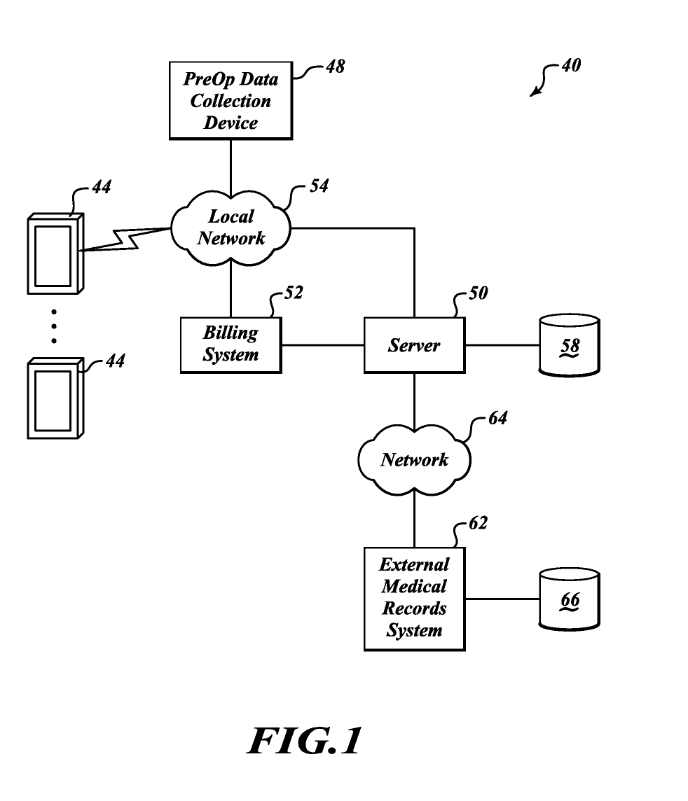

FIG. 1 illustrates an exemplary system 40 that allows an anesthesiologist or an anesthesiology team to review all preoperative information for a patient, enter set-up data associated with a pending operation, enter all relevant anesthesiology information during an operation and generate a presentation of the entire operation process.

In one embodiment, the system 40 includes a computer-based user-interface (anesthesiologist) device 44 that is in signal communication over a local area network 54 to one or more pre-op data collection computer-based devices 48, a central server 50 and a billing system 52. A database 58 is in data communication with the server 50. Also, the server 50 is in data communication with an external medical record system 62 with an associated database 66 over a public or private data network 64. The user interface device 44 provides a graphical user interface (GUI) application program that allows an anesthesiologist to review patient data that has been collected by an operator at one of the pre-op data collection devices 48 and stored locally or on the database 58 associated with the server 50. The GUI application program also allows the anesthesiologist to enter setup information associated with a pending operation and to enter a variety of information during the operation process. The information entered by the anesthesiologist on the device 44 via the GUI application program is stored locally and/or on one of the databases 58 or 66 and some of the information maybe optionally sent to the billing system 52. The billing system 52 may be remotely connected. The billing system 52 may be accessible via the public or private data network 64 (e.g., Internet). The billing system 52 analyzes the information received from the GUI application program in order to generate appropriate billing information. Other data associated with the patient to be operated on that is included in the database 58 or 66 may also be presented to the anesthesiologist via the GUI application program.

In one embodiment, the anesthesiologist device 44 is a computer-based tablet device, such as, but without limitation to, an iPAD® produced by Apple. Other types of computer-based tablet devices may be used provided they include a touch screen user interface. In one embodiment, a barcode or comparable scanner device is either included within the device 44 or is in data communication with the device 44, (such as a camera). The scanner device allows the anesthesiologist to perform a scan of drug containers or other items during the operation process. A component of the GUI application program analyzes the images generated by the scanner device and retrieves information associated with the scanned image and enters it into the presented GUI.

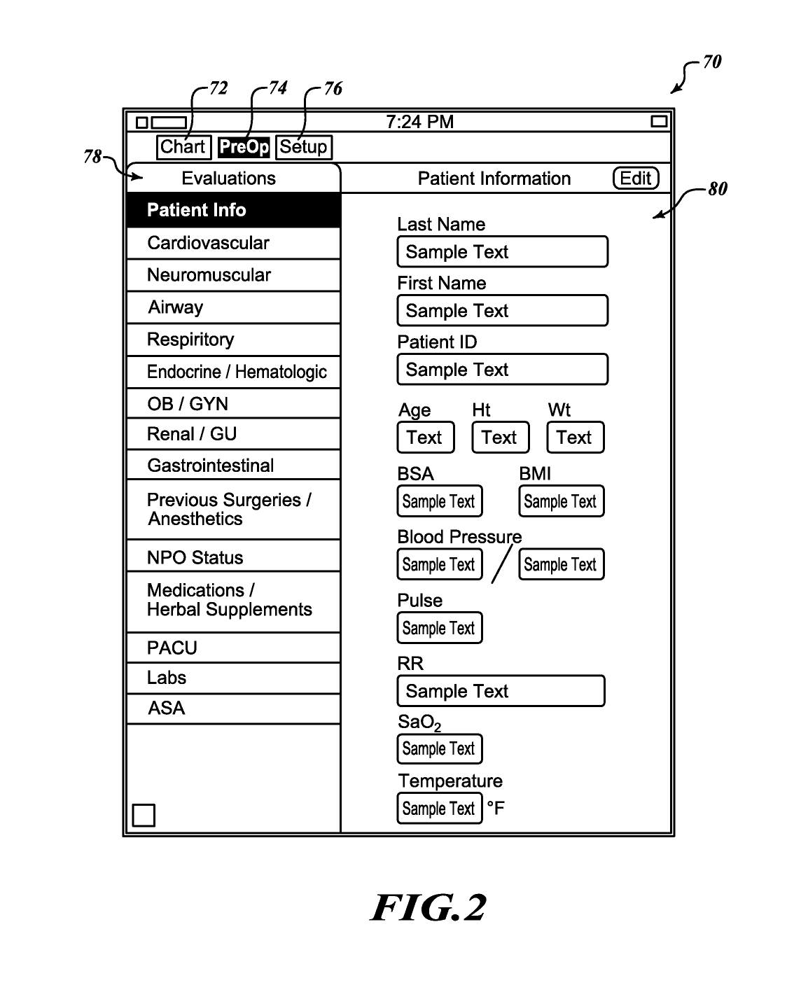

FIG. 2 illustrates an exemplary pre-operation (pre-op) GUI 70. The pre-op GUI 70 like most or all of the pages presented by the GUI application program includes three buttons located approximately at the top of each page. The three buttons include a chart button 72, a pre-op button 74, and a setup (i.e., settings) button 76. User activation of these buttons causes the GUI application program to enter a corresponding operational mode. The pre-op GUI 70 is presented upon user activation of the pre-op button 74. The pre-op GUI 70 includes a plurality of labeled tabs located in an evaluations column 78. Activation by the user of any one of the tabs listed in the evaluations column 78 presents associated information in an information section 80 located adjacent to the evaluations column 78. The information displayed in the section 80 is retrieved from previously entered information that has been entered at pre-op data collection device 48 or comparable device. The pre-op GUI 70, like many or all of the following GUIs, is a native application resident in memory on the device 44. Data is communicated to and from one or more of the databases 58 or 66 and displayed within the appropriate fields of the GUI 70. Communication is secured with encryption (e.g., SSL, TLS).

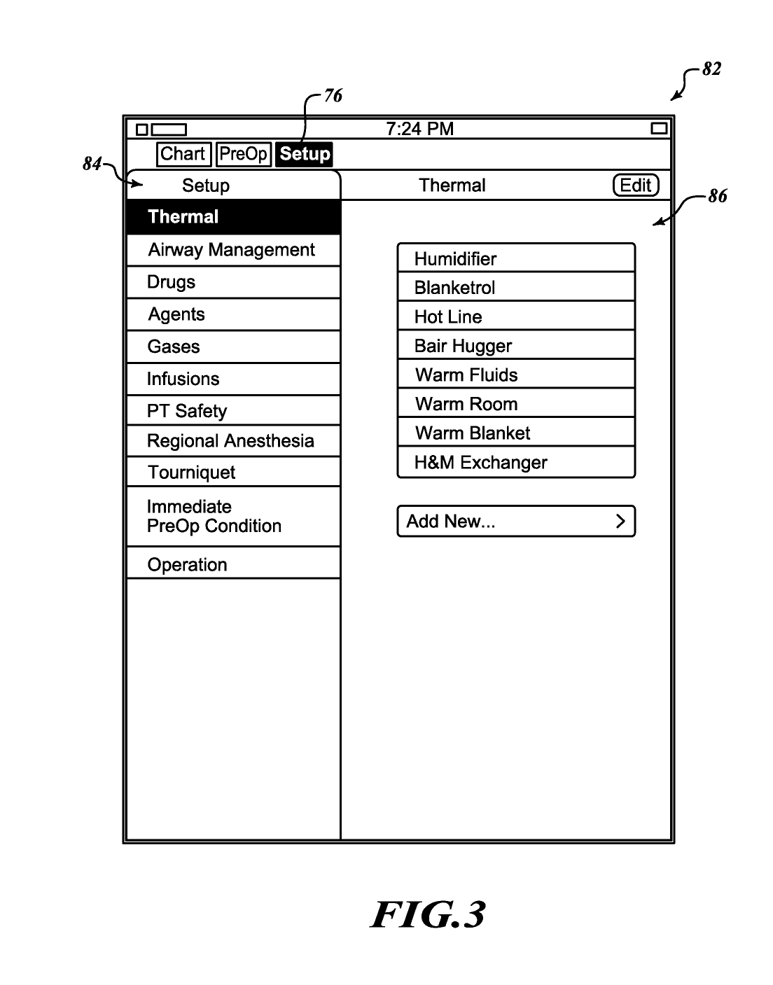

FIG. 3 illustrates a set-up GUI 82 that is presented upon user activation of the set-up button 76. The set-up GUI 82 includes a set-up column 84 that includes a plurality of titled tabs that are associated with a variety of set-up categories associated with a pending operation. Activation of one of the titled tabs in the set-up column 84 presents associated fields within a data entry section 86 located adjacent to the set-up column 84. The anesthesiologist enters information as necessary into the data entry section 86 by highlighting a field which then would present a keyboard or comparable alpha-numeric entry device to allow the user to enter set-up information.

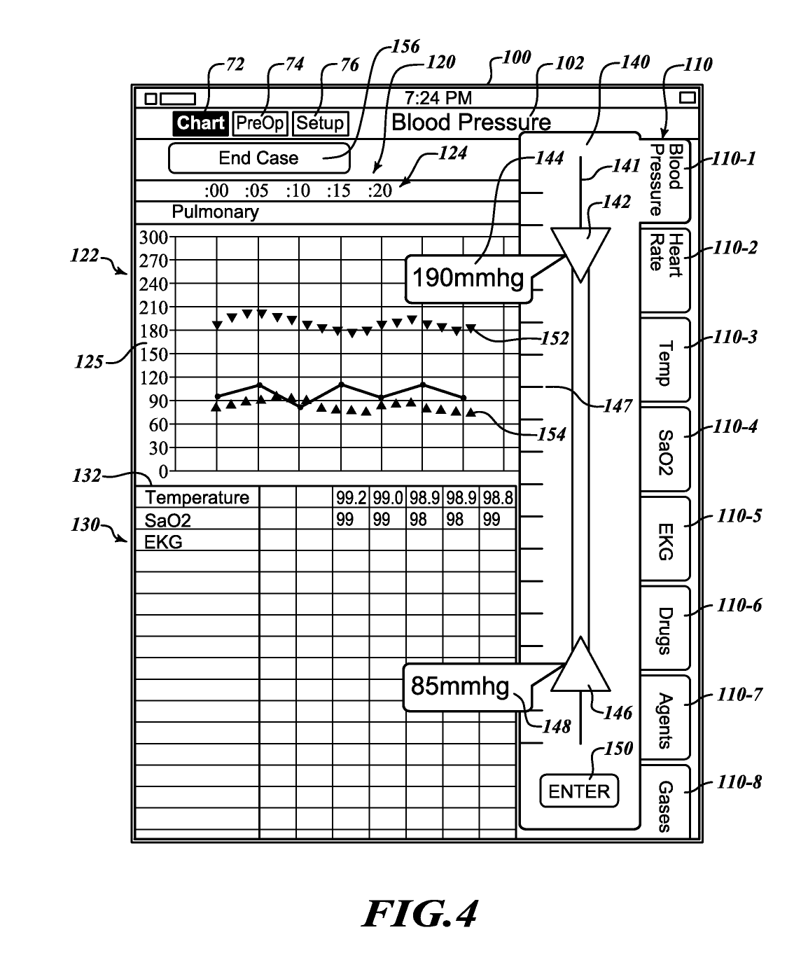

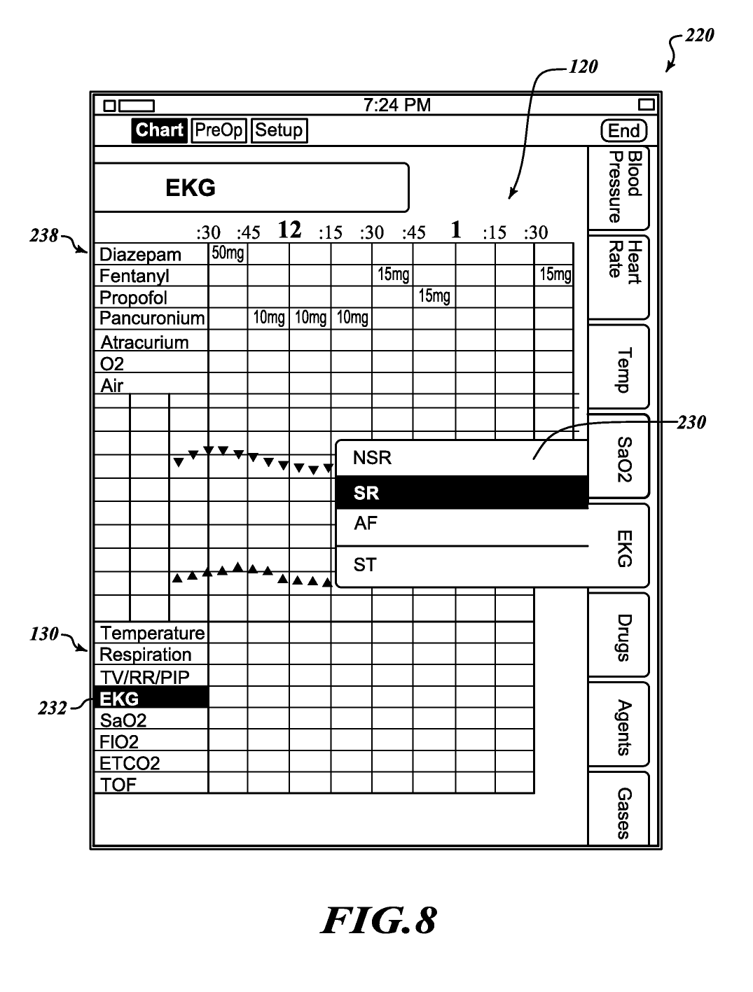

FIGS. 4-12 illustrate an embodiment of a plurality of data entry pages that are available to anesthesiologists once they have begun a case (operation) after having selected the chart button 72. On a right side of the GUI pages presented upon selection of the chart button 72 are a plurality of selectable tabs 110. Presented to the left of the selectable tabs 110 is a timeline table 120. The timeline table 120 includes a column header 124 that presents the time in 5-minute intervals starting from time 0, which is the time in which the anesthesiologist portion of the operation has begun or is the entire time of the operation. The timeline table 120 includes three sections. A first section 238 is a drug administering section and is shown in FIGS. 8-12. A second section 122 of the table 120 is a pulmonary section that includes a left row header 125 beginning at 0 and going to 300. In the area below the column header 124 and right of the left row header 125 is a graph that includes horizontal lines that extend from each of the values in the left row header 125 and vertical lines that extend from the column header 124 in one-minute intervals.

Located below the second section 122 is a third section 130 for showing sampled sensor values. The third section 130 includes a left header column 132 that indicates the sensor values to be sampled, e.g., temperature, SaO₂, etc. Adjacent each of the sensor values are cells that receive data entered by the anesthesiologist associated with the corresponding sampled sensor values or are automatically entered with data collected by sensors that are in data communication (e.g., HL7 language via wireless (e.g., Bluetooth, etc.) or hardwired).

The cells that receive the sampled sensor values are associated with a time value in the column header 124. The timeline table 120 is scrollable either vertically or horizontally by a user by performing a corresponding touch gesture on the table 120.

Some or all of the GUIs as shown in FIGS. 4-12 include an end-case button 156 that when selected will indicated that the data recordation process performed by the anesthesiologist is complete.

The GUI pages of FIGS. 2-12 include a top header 100 that presents the current time and a title 102 that is associated with the tab the user has selected from the plurality of tabs 110.

As shown in FIG. 4, the anesthesiologist has selected a blood pressure tab 110-1 from the plurality of tabs 110. Selection of the blood pressure tab 110-1 presents a blood pressure popup window 140 that includes a vertical column 141 having upper and lower triangles 142, 146. A scale 147 is located to the left of the column 141 and the triangles 142, 146. The scale indicates a blown-up portion of the left row header 125 from the second section 122. In this example, at approximately every minute, the anesthesiologist takes the blood pressure of the patient, then selects the blood pressure tab 110-1 to enter systolic and diastolic pressure measurements. The systolic pressure measurement is entered by moving the upper triangle 142 to a location relative to the scale 147 until the correct pressure value appears in a popup window 144 that is attached with the upper triangle 142. The same action occurs for entering the diastolic pressure using the lower triangle 146 with an associated popup pressure 148. Movement of the triangles 142, 146 is performed by touching the triangle with a finger or stylus then moving the triangles 142, 146 along the column 141.

After the anesthesiologist has entered the correct systolic and diastolic pressure values in the window 140, the anesthesiologist selects an enter button 150. After the anesthesiologist has selected the enter button 150, upper and lower triangles 152, 154 appear on the graph area of the second section 122 at the location selected by the anesthesiologist relative to the left row header 125 at the current time as indicated in the column header 124.

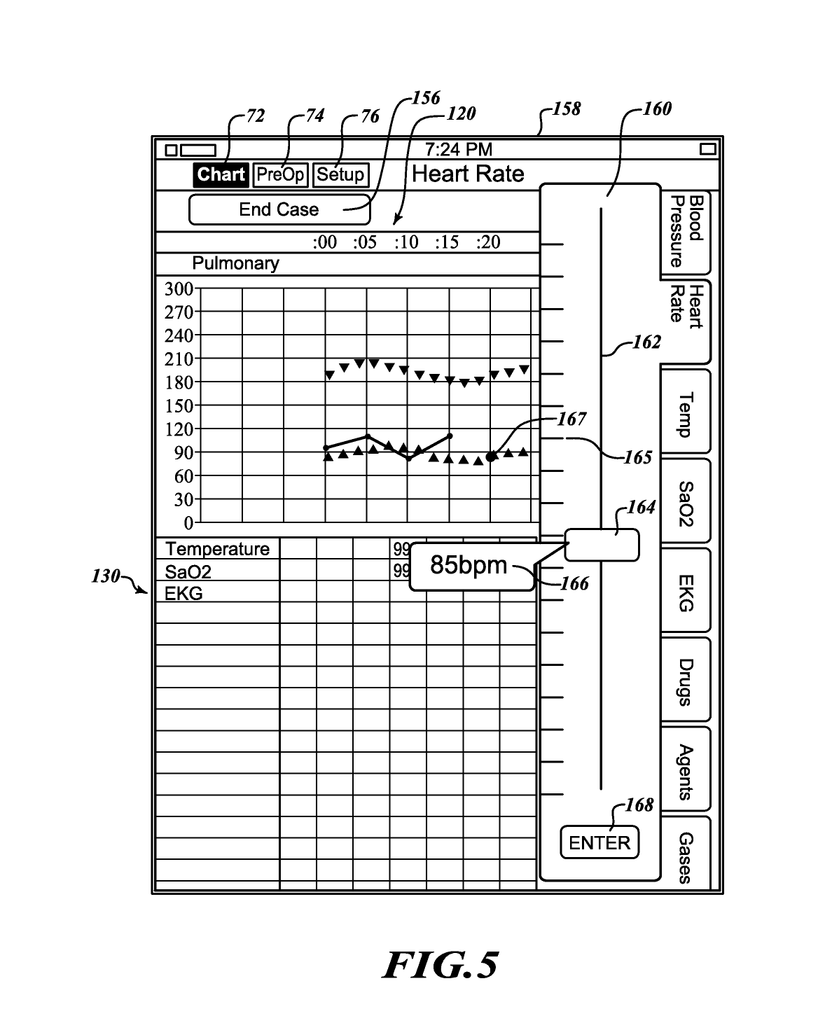

FIG. 5 illustrates a GUI page 158 that is presented upon activation of a heart-rate tab 110-2. A pulse entry window 160 appears upon activation of the heart-rate tab 110-2. The pulse entry window 160 includes a slideable tab 164 that is touch activated and can move up or down along a vertical column 162. Adjacent the vertical column 162 is a scale 165 that represents a blown-up portion of the left row header 125. After the anesthesiologist has taken a blood pressure of the patient, the anesthesiologist activates the tab 164 and moves it along the column 162 to a location relative to the scale 165 in order to match the blood pressure that the anesthesiologist has just acquired. A popup window 166 indicates the blood pressure value that the tab 164 is presently at relative to the vertical scale 165. After the tab 164 has been located at the proper location in the window 160, the anesthesiologist selects an enter button 168, thereby causing the GUI application program to enter a round dot 167 into the graph area of the second section 122 at the proper time on the column header 124 and at the proper vertical location relative the left row header 125.

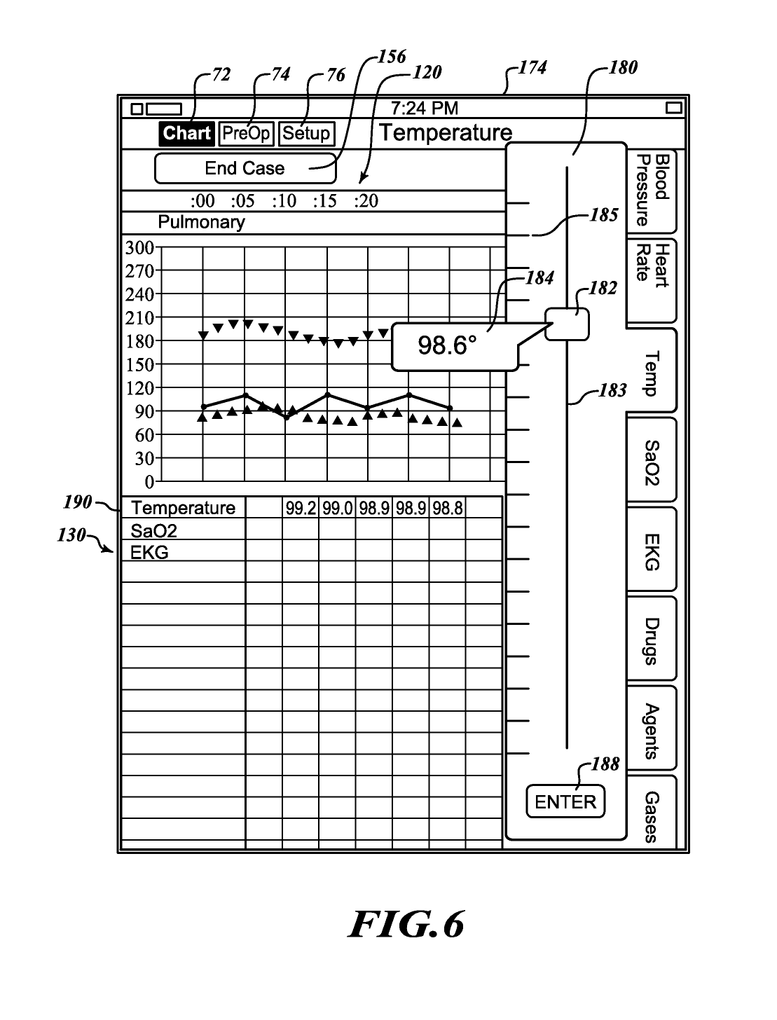

FIG. 6 illustrates a GUI page 174 for entering temperature during the operation. Upon activation of a temperature button 110-3, a popup window 180 similar to the window 160 shown in FIG. 5 is presented. However, in this example, a slideable tab 182 and associated popup window 184 are associated with temperature taken to the tenth of a degree. Adjacent to a column 183 that the tab 182 slides up and down on is a vertical scale 185 with tick marks that represent of tenths of a degree. Other values for the scale 185 may be used. Once the anesthesiologist has moved the touch-sensitive tab 182 to the location that will indicate a temperature value in the popup window 184 that is equivalent to a temperature value of the patient, the anesthesiologist activates an enter button 188 included in the popup window 184. Activation of the enter button 188 enters the value presented in the popup window 184 into a cell of a temperature row 190 in the third section 130. The cell that receives the temperature value is the one associated with the current time according to the column header 124.

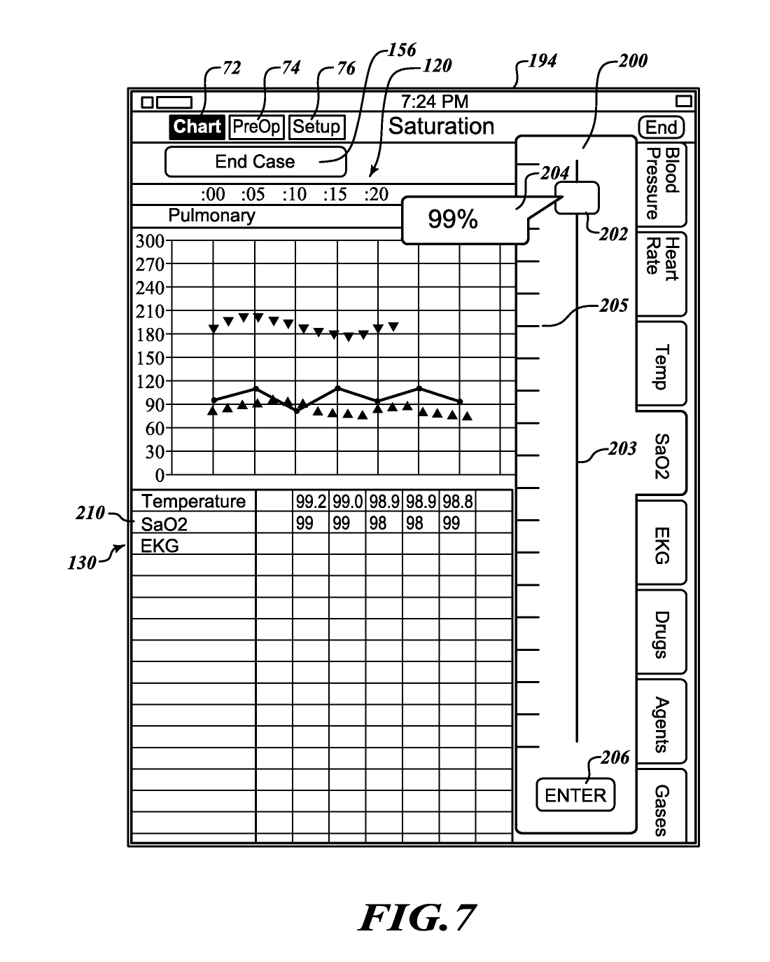

FIG. 7 illustrates a saturation GUI page 194 that is presented upon activation of an SaO₂ tab 110-4. Activation of the SaO₂ tab 110-4 presents a popup window 200 that includes a touch-sensitive vertically scrollable tab 202 that scrolls along a column 203 adjacent a scale 205 of oxygen saturation values. A value popup window 204 appears adjacent the tab 202 to indicate the saturation value (%) that the tab 202 is located at relative to the adjacent scale 205. Once the anesthesiologist has located the scrollable tab 202 at a location along the column 203 relative to the scale 205 having a saturation value that is equivalent to the currently tested oxygen saturation level of the patient, the anesthesiologist selects an enter button 206 located within the popup window 200. The value within the oxygen saturation value popup window 200 is then entered into a previously empty cell in an oxygen saturation row 210 included in the third section 130.

The touch-sensitive scrollable tabs included in the popup windows 140, 160, 180 and 200 may be moved to the ends of the presented scales within those respective windows and if held at those locations for more than a predefined amount of time, the entire scale, in other words the adjacent scale to the left, will move in the direction opposite the direction that the tab has been moved in order to access other values associated with the sample values that are not initially presented in the respective popup window. With regard to the popup window 140 as shown in FIG. 4, scrolling or moving the triangles 142 and 146 outside or to the limits of the vertical column 141 causes the tick marks in the left scale 147 to become closer together or causes the tick marks to remain stationary and changes the values associated with each of the tick marks. In either case this alteration of the scale 147 included within the popup window 140 would accommodate the movement of one of the triangles 142, 146 to move to the limit of the vertical column within the popup window 140 without the other triangle 142, 146 from disappearing off the visual portion of the popup window 140. In another embodiment, the scale 147 remains the same both in distance between the tabs and the assigned value to the tick marks. In this case one of the triangles 142, 146 may scroll off the visible portion of the column 141 within the popup window 140 if the other triangle 142, 146 was to move to a location along the vertical column 141 that is greater than the limits of the scale 147. The anesthesiologist can touch the screen with a particular gesture in order to access the nonvisible triangle 142, 146 in order to adjust or verify that triangles value. Similar type of scrolling/movement of tabs is performed in the other popup windows.

FIG. 8 illustrates an EKG GUI page 220 that presents an EKG popup window 230 after the anesthesiologist has selected an EKG tab 110-5. The EKG popup window 230 includes a list of EKG reading anomalies. Upon selection of one of the four anomaly notations, the notation is placed into a row 232 of the third section 130 indicating that the particular anomaly occurred during that timeframe.

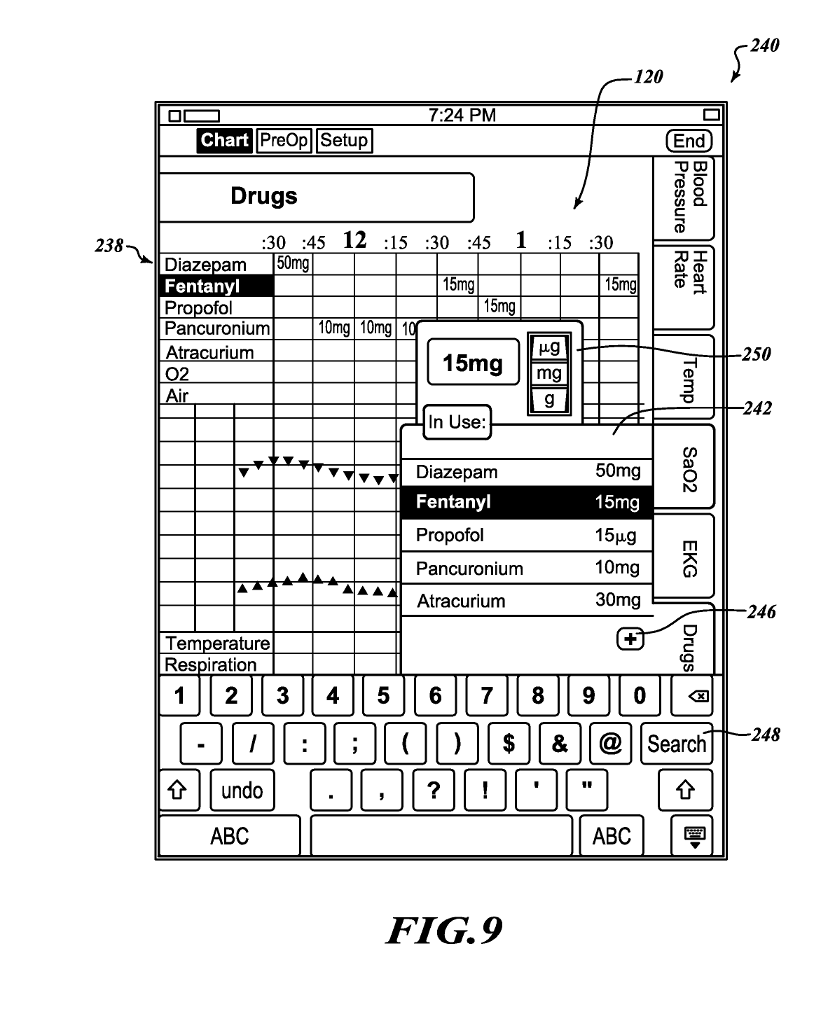

FIG. 9 illustrates a drug entry GUI page 240 that allows the anesthesiologist to enter drug quantity and time information into the chart. A drug use popup window 242 appears after the anesthesiologist has selected a drugs tab 110-6. The drug use popup window 242 includes a list of drugs that are in use with an associated quantity for each. After the anesthesiologist has administered a drug from the in-use group, the anesthesiologist selects that drug by touching the drug name within the drug use popup window 242. Activating a drug within the window 242 presents a dosage window 250 that is identified with a cell within the first section 238 of the table 120. The dosage entry window 250 includes a field that indicates a quantity of drug that the anesthesiologist has selected using a keyboard 248 that is presented at the bottom of the GUI page 240. Also included in the dosage window 250 is a touch-sensitive spinnable wheel that identifies the weight scale associated with the number included in the adjacent field. In one embodiment, the scrollable scale includes grams (g), milligrams (mg), or micrograms (μg). Other weight or quantity values can be used in the alternative. In the example shown, the anesthesiologist has selected the in-use drug of Fentanyl with an entered quantity of 15 mg. Entry of the selected drug and quantity are entered into the first section 238 by activation of an enter button (not shown), a function key, a location outside of the window 242 or by some other comparable method.

The drug use popup window 242 includes a plus button 246 that allows the user to add drugs not included in the in-use list.

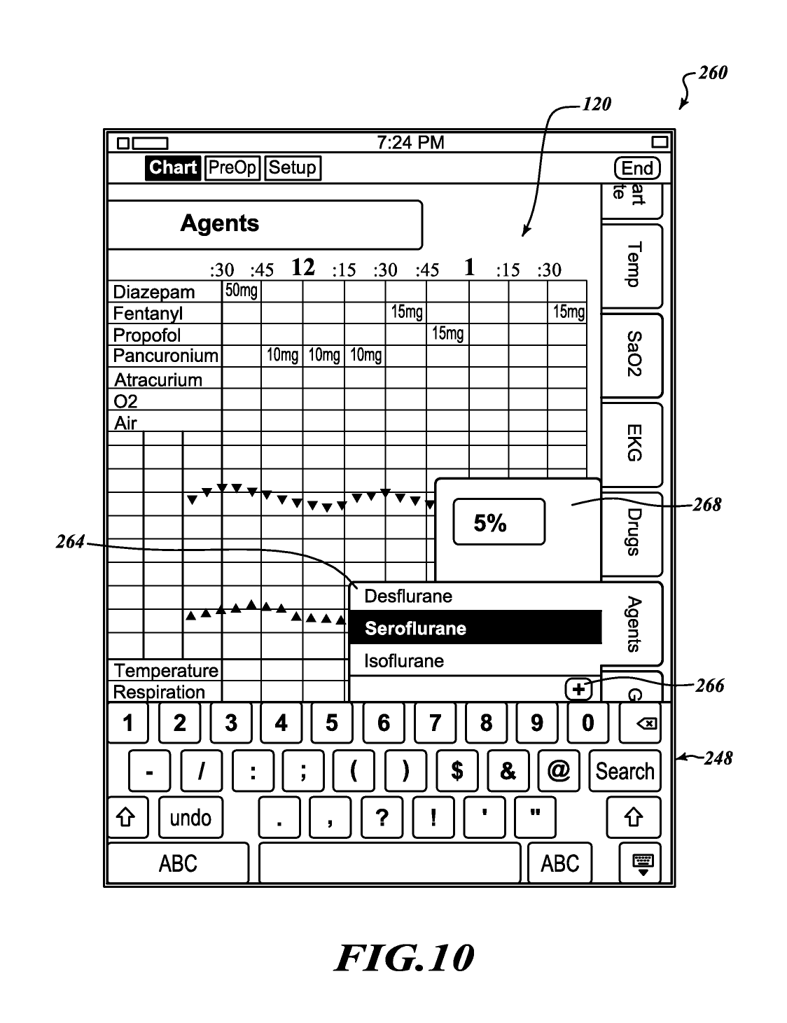

FIG. 10 illustrates an agents GUI page 260. Once the anesthesiologist has selected an agents tab 110-7 an agent's popup window 264 illustrates agents available for selection by the anesthesiologist. Once the anesthesiologist selects one of the agents, a percentage entry window 268 pops up as well as the keyboard 248 for allowing the anesthesiologist to select a percentage amount of the selected agent. The anesthesiologist can select other agents that are not displayed in the agent popup window 264 by activation of a plus button 266. In this example the anesthesiologist has selected the Seraflurane agent at a percentage of 5.

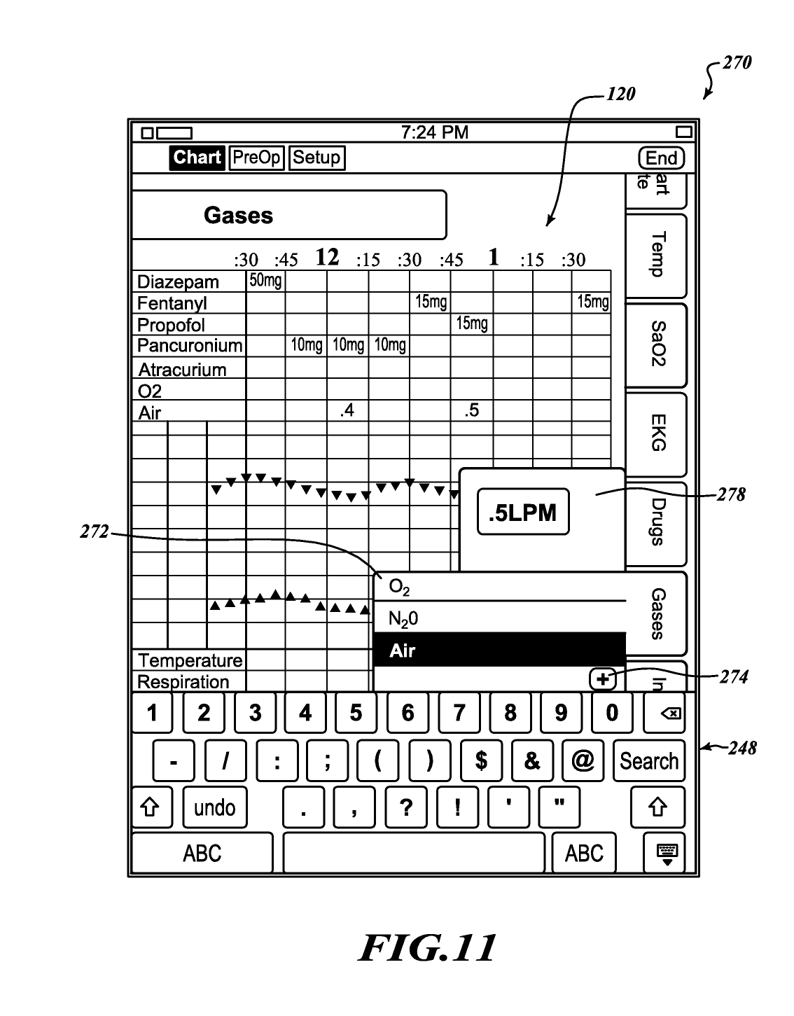

FIG. 11 illustrates a gases GUI page 270 that allows the anesthesiologist to enter a gas value into the first section 238. Activation of a gases tab 1108 presents a gasses popup window 272 that lists some common gasses available to the anesthesiologist. Activation of one of the gasses listed in the popup window 272 presents the keyboard 248 and a quantity entry window 278 that allows the user to enter a quantity in liters per minute (lpm), which is the default base quantity. In this example, the anesthesiologist has selected air at a quantity of 0.5 lpm. The value selected is entered in to the first section 238 in manners described above. If the anesthesiologist wants to select a gas that is not in the presented list then the anesthesiologist selects a plus button 274 to select or enter a gas as desired.

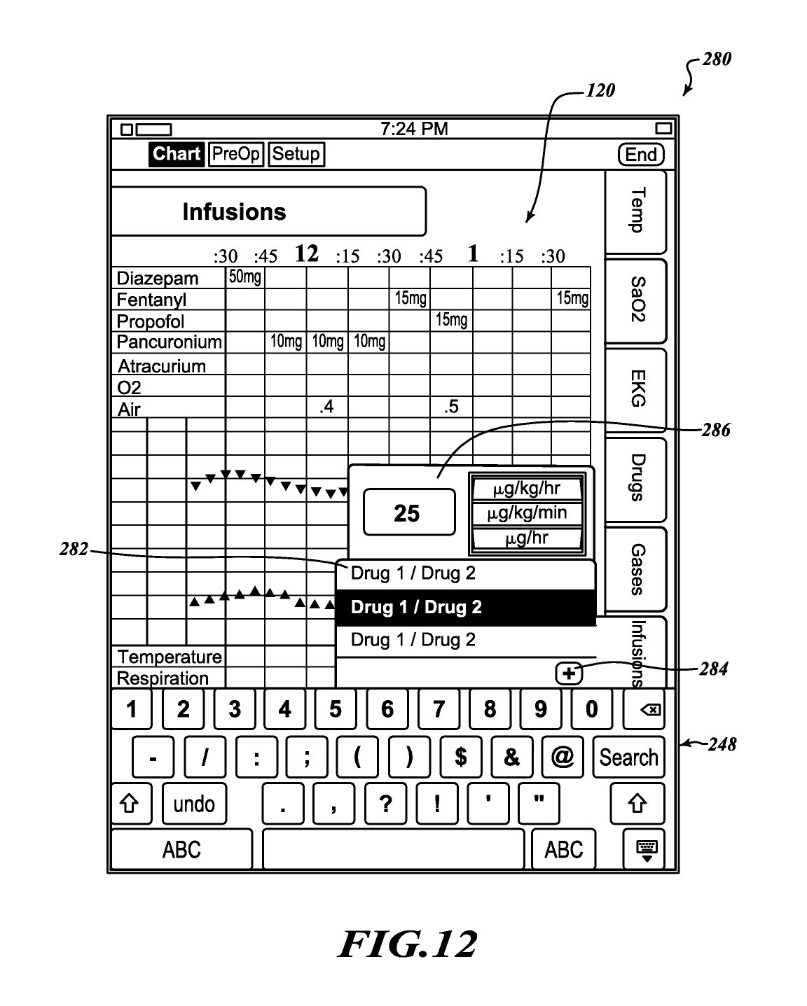

FIG. 12 illustrates an infusions GUI page 280 that allows the anesthesiologist to enter infusions information into the table 120. Once the anesthesiologist has selected an infusions tab 110-9, a drug infusions popup window 282 appears. This window 282 allows a provider to list a drug and at what rate it would be delivered at as opposed to a drugs given as bolus, all at once, as shown in FIG. 9. A drug can be given on a continuous basis and stopped at appropriate time, when ever that may be. For example, if a provider wants to give fentanyl continuously to maintain a steady state of pain relief for patient, they will give an infusion. Infusions are usually, amount of drug per weight per time, such as, μg/kg/min. There are many ways to give infusions cc/hr, cc/min, μg/min, μg/hr, g/min etc.

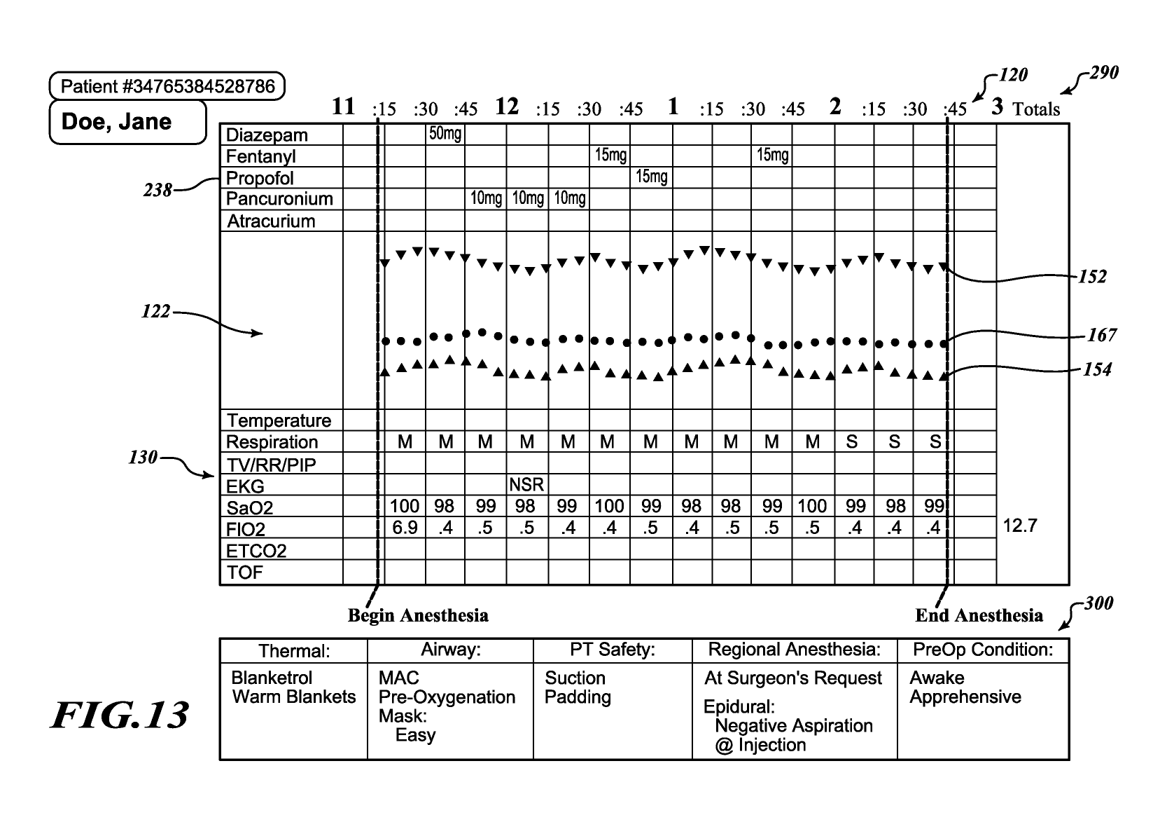

Upon completion of the anesthesiology portion of an operation, the anesthesiologist activates the end-case button 156. Activation of the end-case button 156 causes the generation of a final record as shown in a final records page 290 as shown in FIG. 13. The final records page 290 includes a completed table 120 showing the first section 238, the second section 122 and the third section 130. Included within the second section 122 are the systolic and diastolic triangles 152, 154 and the blood pressure dots 167. Below the table 120 is a list of associated anesthesiological information in a table 300. The bottom table 300 provides notes and other data from the operation.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A computer readable-medium having instructions that when executed by a processor generate a graphical user interface, the graphical user interface comprising:
a table comprising a time axis and values axis; and
a slider device comprising a user-activated tab located adjacent a scale, wherein the tab is configured to move within the scale and the scale corresponds to the values axis of the table,
wherein the range of the scale is equivalent to only a portion of the values axis.

2. The graphical user interface of claim 1, wherein the scale and the values axis have a length, the length of the scale being greater than the length of the values axis.

3. The graphical user interface of claim 2, wherein the slider comprises two slideable tabs, wherein the values axis covers traditional blood pressure readings, wherein one of the tabs is associated with a systolic reading and the other tab is associated with a diastolic reading, wherein systolic and diastolic indicators are presented in the table after user selection of values associated with the tabs.

4. The graphical user interface of claim 2, wherein the values axis covers traditional heart rate readings wherein a heart rate indicator is presented in the table after a user selection of the value associated with the tab.

5. The graphical user interface of claim 1, wherein the table comprises sensed values rows located along the same axis as the values axis, wherein the sensed values rows comprises a temperature row, an oxygen saturation row and an EKG row.

6. The graphical user interface of claim 5, wherein the table comprises one or more drug entry rows located along the same axis as the values axis, wherein the one or more drug entry rows receive user selections of one or more administered drugs.

7. A method performed by a tablet computing device, the method comprising:
starting an operation charting program;
displaying a table comprising a time axis and values axis;
displaying a slider device comprising a user-activated tab located adjacent to a scale, wherein the tab is configured to move within the scale based on user activation and the scale corresponds to the values axis of the table,
wherein a range of the scale is equivalent to only a portion of the values axis.

8. The method of claim 7, wherein the scale and the values axis have a length, the length of the scale being greater than the length of the values axis.

9. The method of claim 8, wherein the slider comprises two slideable tabs, wherein the values axis covers traditional blood pressure readings, wherein one of the tabs is associated with a systolic reading and the other tab is associated with a diastolic reading, further comprising displaying systolic and diastolic indicators in the table after reception of user selection of values associated with the tabs.

10. The method of claim 8, wherein the values axis covers traditional heart rate readings, further comprising displaying a heart rate indicator in the table after reception of a user selection of the value associated with the tab.

11. The method of claim 7, further comprising displaying sensed values rows located along the same axis as the values axis, wherein the sensed values rows comprises a temperature row, an oxygen saturation row and an EKG row.

12. The method of claim 11, further comprising displaying one or more drug entry rows located along the same axis as the values axis, wherein the one or more drug entry rows present user selections of one or more administered drugs.

13. The method of claim 12, further comprising displaying a final chart upon operation completion.

14. The method of claim 7, further comprising receiving data from one or more sensors and automatically entering the received data into the displayed table.

15. A tablet computing device configured to couple to at least one network, the tablet computing device comprising a computer readable-medium having instructions that when executed by a processor of the tablet computing device generate a graphical user interface, the graphical user interface comprising:
a table comprising a time axis and values axis; and
a slider device comprising a user-activated tab located adjacent a scale, wherein the tab is configured to move within the scale and the scale corresponds to the values axis of the table,
wherein a range of the scale is equivalent to only a portion of the values axis.

16. The device of claim 15, wherein the scale and the values axis have a length, the length of the scale being greater than the length of the values axis.

17. The device of claim 16, wherein the slider comprises two slideable tabs, wherein the values axis covers traditional blood pressure readings, wherein one of the tabs is associated with a systolic reading and the other tab is associated with a diastolic reading, wherein systolic and diastolic indicators are presented in the table after user selection of values associated with the tabs.

18. The device of claim 15, wherein the values axis covers traditional heart rate readings and wherein a heart rate indicator is presented in the table after reception of a user selection of the value associated with the tab.

19. The device of claim 16, wherein the table comprises sensed values rows located along the same axis as the values axis, wherein the sensed values rows comprises a temperature row, an oxygen saturation row and an EKG row.

20. The device of claim 19, wherein the table comprises one or more drug entry rows located along the same axis as the values axis, wherein the one or more drug entry rows receive user selections of one or more administered drugs.

21. A computer-based system comprising:
a network;
a data entry device being in signal communication with the network;
a billing system being in signal communication with the network;
one or more tablet computing devices being in signal communication with the network, the tablet computing device comprising a computer readable-medium having instructions that when executed by a processor of the tablet computing device generates a graphical user interface, the graphical user interface comprising:
a table comprising a time axis and values axis;
a component configured to display information received by the data entry device; and
a slider device comprising a user-activated tab located adjacent a scale, wherein the tab is configured to move within the scale and the scale corresponds to the values axis of the table,
wherein a range of the scale is equivalent to only a portion of the values axis,
wherein tablet computing device is configured to display a final chart upon operation completion,
wherein the billing system is configured to receive at least a portion of the information included in the final chart,
wherein the data entry device comprises automatically receiving data from a sensor.
